(19) United States
(12) Patent Application Publication
(10) Pub. No.: US 2024/0404434 A1
(43) Pub. Date: Dec. 5, 2024

(54) HOLDER ASSEMBLY FOR FLAGPOLE ROD AND THE LIKE

(71) Applicant: ROSWELL CANADA INC., ACHESON (CA)

(72) Inventor: Jonathan D. GLOVER, Edmonton (CA)

(21) Appl. No.: 18/204,988

(22) Filed: Jun. 2, 2023

(51) Int. Cl. G09F 17/00; A01K 97/10

(52) U.S. Cl. CPC G09F 17/00; A01K 97/10

(57) ABSTRACT

An apparatus (100), including: a holder (102) configured to hold a rod, wherein the holder is configured to tilt about a pivot joint (120); and a pinching element (122) held in a fixed position relative to the holder and comprising a contact surface (124), in A distance (D1) between the contact surface and an interior surface (108) of the holder opposite the contact surface decreases as the holder tilts about the pivot joint toward a pinching configuration.

### FIELD OF THE INVENTION

The invention relates to holder assemblies used to retain flagpoles, fishing rods, and the like.

### BACKGROUND OF THE INVENTION

Flags are often mounted to boats via flagpole holders. Certain flagpole holders secure the flagpole therein to prevent wind drag on the flag from lifting the flagpole out of the holder in transit. Known securing mechanisms require tools that may not be conveniently accessible on the boat. This makes installing the flagpoles in the holders and removing them therefrom more cumbersome. Hence, there remains room in the art for improvement.

### BRIEF DESCRIPTION OF THE DRAWINGS

The invention is explained in the following description in view of the drawings that show:

FIG. 1 is a schematic representation of an example embodiment of a rod holder assembly in an unpinched configuration.

FIG. 2 is a schematic representation of the rod holder assembly of FIG. 1 showing initial motions associated with tilting toward a pinched configuration.

FIG. 3 is a schematic representation of the rod holder assembly of FIG. 1 showing final motions associated with reaching the pinched configuration.

FIG. 4 is a schematic representation of the rod holder assembly of FIG. 1 showing forces acting on the rod in the pinched configuration.

FIG. 5 shows an alternate example embodiment of the rod holder assembly in the unpinched configuration.

FIG. 6 shows an example configuration of the rod holder assembly of FIG. 5 in the pinched configuration.

FIG. 7 shows an alternate example configuration of the rod holder assembly of FIG. 5 in the pinched configuration.

FIG. 8 shows a cross section taken along line A-A of FIG. 7.

FIG. 9 shows a holder of the rod holder assembly of FIG. 5.

FIG. 10 shows a base of the rod holder assembly of FIG. 5.

FIG. 11 is a schematic representation of another alternate example embodiment of a rod holder assembly in an unpinched configuration.

FIG. 12 is a schematic representation of the rod holder of FIG. 11 showing initial motions associated with tilting toward the pinched configuration.

FIG. 13 is a schematic representation of the rod holder of FIG. 11 showing forces acting on the rod in the pinched configuration.

### DETAILED DESCRIPTION OF THE INVENTION

The present inventor has developed a unique and innovative rod holder that requires no tools to install or to remove the rod and which uses naturally occurring forces on the rod to pinch and thereby secure the rod in the holder during use. This rod holder thereby simplifies installation and removal of the rod while improving retention of the rod in the holder. The rod holder is suitable for holding a variety of rod, poles, and the like. The rod holder is particularly beneficial for flagpoles and fishing rods because each of these experiences lateral forces during use. Wind resistance creates drag on the flag which applies a lateral force on the flagpole. A fish pulling on a line also creates a lateral force on the pole. In both cases, these forces may normally tend to draw the pole/rod out of the holder, but due to the design disclosed herein, these forces contribute to the retention of the pole/rod in the holder.

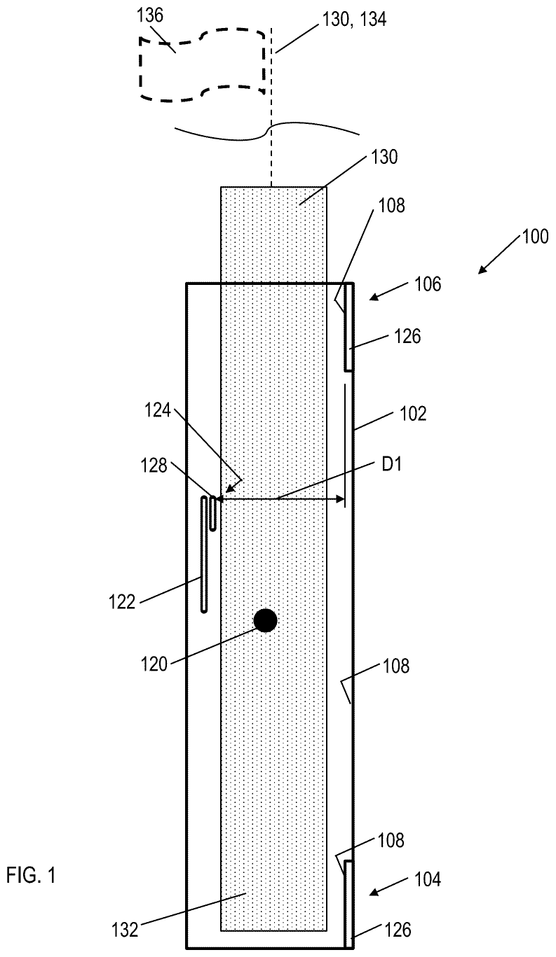

FIG. 1 is a schematic representation of an example embodiment of a rod holder assembly 100 in an unpinched configuration and including a holder 102 having a first end 104 configured to retain a rod disposed in the holder 102 (e.g., via a cross pin or the like), a second end 106 that is open and thereby able to receive the rod therethrough and into the holder 102, and an interior surface 108 configured to contact the rod disposed therein.

The rod holder assembly 100 further includes a pivot joint 120 configured to permit the holder 102 to rotate/tilt therearound, and a pinching element 122 having a contact surface 124 that is held in a fixed position relative to the holder 102.

The holder 102 may include optional interior surface grip features 126 that define part of the interior surface 108 of the holder 102. Similarly, the pinching element 122 may include optional pinching element grip features 128 that define the contact surface 124. These grip features may include features configured to enhance a grip on the rod, such as rubber grip materials and ribs, hooks, barbs and the like.

A flagpole 130 having a proximate end 132 disposed in the holder 102 and a distal end 134 with a flag 136 attached thereto is used herein to describe the function of the rod holder assembly 100. However, a fishing pole can be used and will function similarly, and any other pole can be held by the rod holder assembly 100.

In the unpinched configuration shown, holder 102 is oriented vertically upright with the first end 104 directly below the second end 106 The proximate end 132 is disposed in the holder 102 and the distal end 134 is, depending on the degree of looseness of the flagpole 130 in the holder 102, disposed generally vertically above the proximate end 132. A distance D1 indicates a lateral clearance of the flagpole 130 in the holder 102. Since distance D1 is greater than the diameter of the flagpole 130, the flagpole 130 can readily be installed in and removed from the holder 102 without using any tools.

The magnitude of distance D1 can be adjusted up to create more clearance and a greater looseness of the flagpole 130 in the holder 102. Alternately, the magnitude of distance D1 can be adjusted down to create less clearance and a lesser looseness of the flagpole 130 in the holder 102.

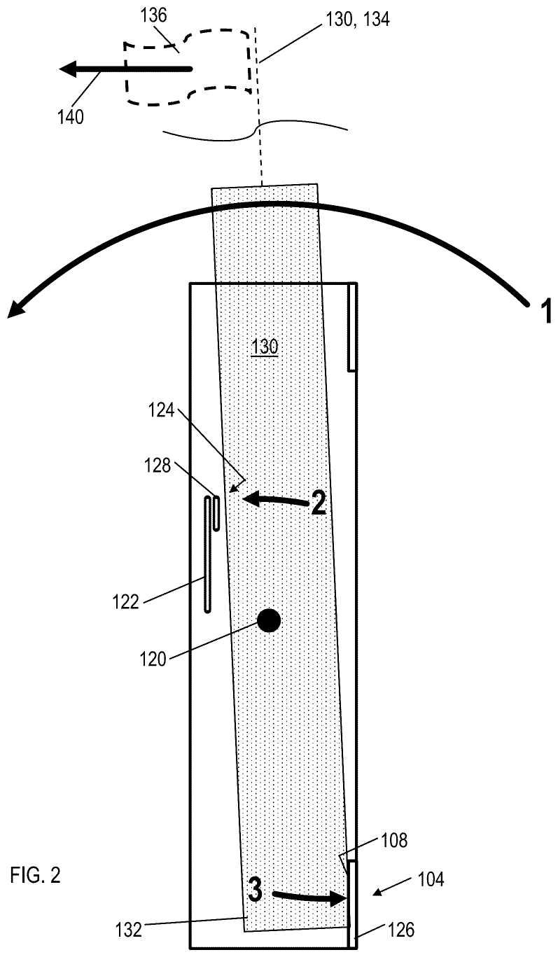

FIG. 2 is a schematic representation of the rod holder assembly 100 of FIG. 1 showing initial motions associated with tilting toward a pinched configuration. The flagpole 130 may be tilted by hand and/or by an external force 140 (e.g., a tilting force) such as wind-induced drag or a fish pulling on a line. The flagpole 130 tilts initially as indicated by arrow 1 until the flagpole 130 contacts the contact surface 124 of the pinching element 122. Upon sufficient tilting, the flagpole 130 then contacts the contact surface 124, as indicated by arrow 2. The contact surface 124 then becomes the location around which the flagpole 130 pivots. Further application of the external force 140 causes the flagpole 130 to further rotate about the contact surface 124 until it abuts the interior surface 108 at the first end 104 of the holder 102. This intermediate configuration is indicated by arrow 3.

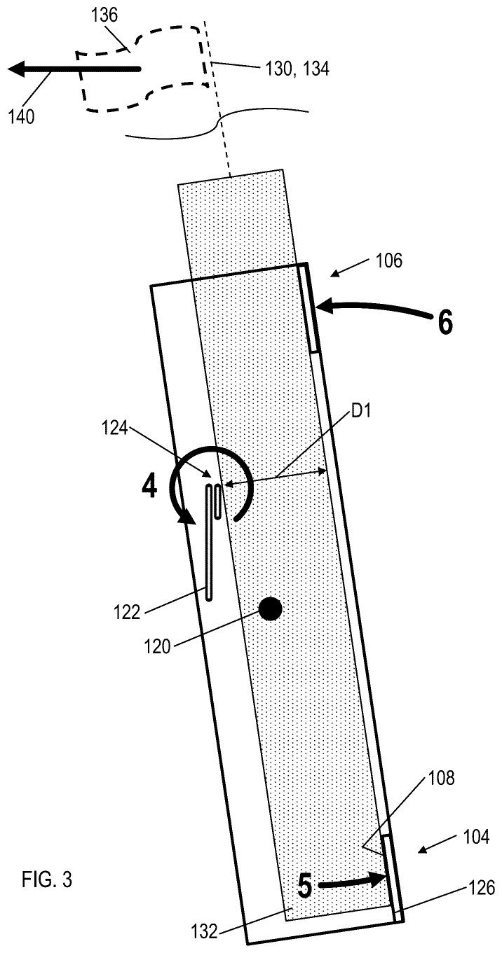

FIG. 3 is a schematic representation of the rod holder assembly 100 of FIG. 1 showing final motions associated with reaching the pinched configuration shown. After reaching the intermediate configuration shown in FIG. 2, continued application of the external force 140 by hand and/or by the external force 140 etc. causes the flagpole 130 to continue rotating about the contact surface 124. This further kicks out the proximate end 132 of the flagpole 130 to the right, which takes the first end 104 of the holder 102 with it. When the first the first end 104 of the holder 102 so moved, the holder 102 rotates about the pivot joint 120. This causes the second end 106 of the holder 102 to rotate about the pivot joint 120 and progressively reduces the distance D1 until the interior surface 108 at the second end 106 of the holder 102 contacts the flagpole 130. This is indicated by arrow 6. Once this final contact occurs, flagpole 130 is pinched between the contact surface 124 of the pinching element 122 and the interior surface 108 of the holder 102 in the pinched configuration.

In the case of a round flagpole 130, the distance D1 in the pinched configuration is no larger than the diameter of the flagpole 130. In some configurations, there may be more than one contact surface 124 and the plural contact surfaces may be distributed along the perimeter of the flagpole. In that configuration, there may be a respective and possibly different distance D1 for each contact surface.

In the pinched configuration of FIG. 3, the contact surface 124 is disposed between the pivot joint 120 and the second end 106 of the holder 102. In this configuration, continued application of the external force 140 interlocks the flagpole 130, the holder 102, and the pinching element 122. When interlocked, at least friction between the contact surface 124 and the flagpole 130, and between the interior surface 108 and the flagpole 130 retains the flagpole 130 in the holder 102.

The friction can be enhanced by selection of materials for the optional interior surface grip features 126 and the optional pinching element grip features 128. The grip can also be enhanced by including mechanical grips like ribs, barbs, and/or hooks and the like.

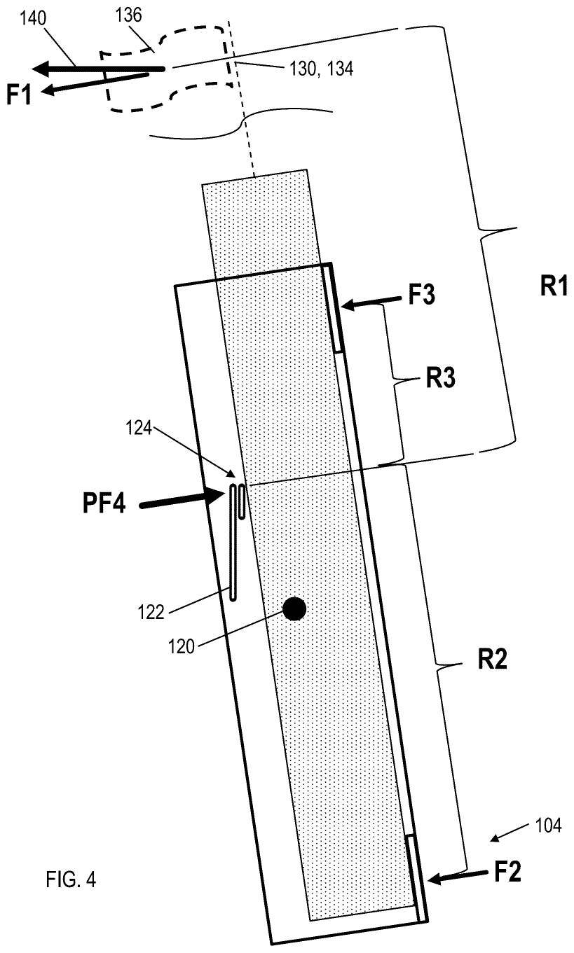

Due to this geometry, once in the pinched configuration, a magnitude of the friction forces holding the flagpole 130 in place is proportional to a magnitude of the external force 140. This is advantageous because, for example, increasing wind drag, which increasingly urges the flagpole 130 from the holder, is now also being used to increase the holder's grip on the flagpole 130. Because of the holder assemblies disclosed herein, more retention is provided when more retention is needed without the user needing to do anything or use any tools. When the external force 140 is sufficiently reduced or eliminated, the flagpole 130 can be removed by hand without the user needing to use any tools. 5 FIG. 4 is a schematic representation of the rod holder assembly 100 of FIG. 3 and models forces acting on the flagpole 130 in the pinched configuration.

A first force F1 acts perpendicular to the flagpole 130. It may be a component of the external force 140, or if the external force 140 is perpendicular to the flagpole 130, it may be an entirety of the external force 140. The first force F1 at radius R1 from the contact surface 124 generates a counterclockwise first moment around the pivot joint 120.

A second force F2 at radius R2 from the contact surface 124 is imparted to the flagpole 130 by the first end 104 of the holder 102 and creates a clockwise second moment around the pivot joint 120.

A third force F3 at radius R3 from the contact surface 124 is imparted to the flagpole 130 by the second end 106 of the holder 102 when the second end 106 is pushed onto the flagpole by the counterclockwise rotation indicated by arrow 6 in FIG. 3. The third force F3 at radius R3 from the contact surface 124 creates a counterclockwise third moment around the pivot joint 120.

In the equilibrium pinched configuration shown, the clockwise moments counter all the counterclockwise moments on the flagpole 130.

A fourth force PF4, a pinching force, is imparted by the contact surface 124 of the pinching element 122. The pinching force PF4 is opposite in direction and equal in magnitude to the sum of forces F1, F2, and F3.

As the external force 140 and associated first force F1 increase, the second force F2 and the third force F3 increase proportionally to maintain the equilibrium of the moments. Since the pinching force PF4 is the sum of forces F1, F2, and F3, proportional increases to F1, F2, and F3 cause the pinching force PF4 to likewise increase proportionally. This proportionally increases the friction forces that retain the flagpole 130 in the holder 102.

Increasing the first force F1 may further increase geometric interlocks between the flagpole 130 and, if used, mechanical grips of the optional interior surface grip features 126 and the optional pinching element grip features 128. Mechanical grips like ribs or hooks may be ideal for a flagpole having a softer material where the grips contact. In such an embodiment, the ribs/hooks etc. may bite into the flagpole and thereby increase retention, and the amount of bite may increase as the first force F1 is increased.

Various other embodiments disclosed herein function similarly but may differ as discussed. In addition, the forces and moments disclosed herein make certain modeling assumptions such as perfectly rigid bodies etc. to explain the principles. In practice, the forces/mechanics experienced may be different.

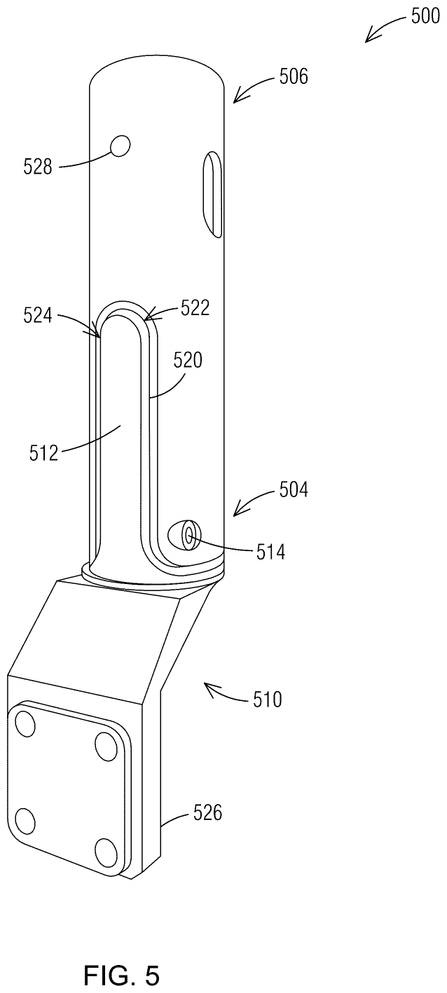

FIG. 5 shows an alternate example embodiment of the rod holder assembly 500 in the unpinched/untilted configuration. The rod holder assembly 500 includes the holder 502 having the first end 504 and the second end 506, a base 510 having the pinching element 512, and the pivot joint 514 between the holder 502 and the base 510 at the first end 504 of the holder 502.

The pivot joint 514 enables the holder 502 to pivot/tilt relative to the base 510 so the base 510 can remain stationary relative to the holder 502. The pinching element 512 extends from the base 510 toward the second end 506. The holder 502 comprises a relief 520 configured to permit the pinching element 512 to pass into the holder 502 as the holder 502 tilts toward the pinching configuration. The pinching element 512 shown is configured to occupy the relief 520 when the holder 502 is in the fully unpinched/untilted position shown, although the pinching element 512 could be outside or inside the relief. In an alternate example embodiment, the pinching element 512 may extend inside the holder 502 and there may be no relief 520. The pinching element 512 is also shaped/curved to match the portion of the cylindrical shape of the holder 502 left unoccupied by the relief 520. The contact surface 522 is disposed at a distal end 524 of the pinching element 512. The base 510 is secured to a mount 526 that may be integral with or discrete from the base 510. One or more optional fastener openings 528 may be present and may be threaded or otherwise configured to receive set screws and the like to secure the flagpole 130 therein.

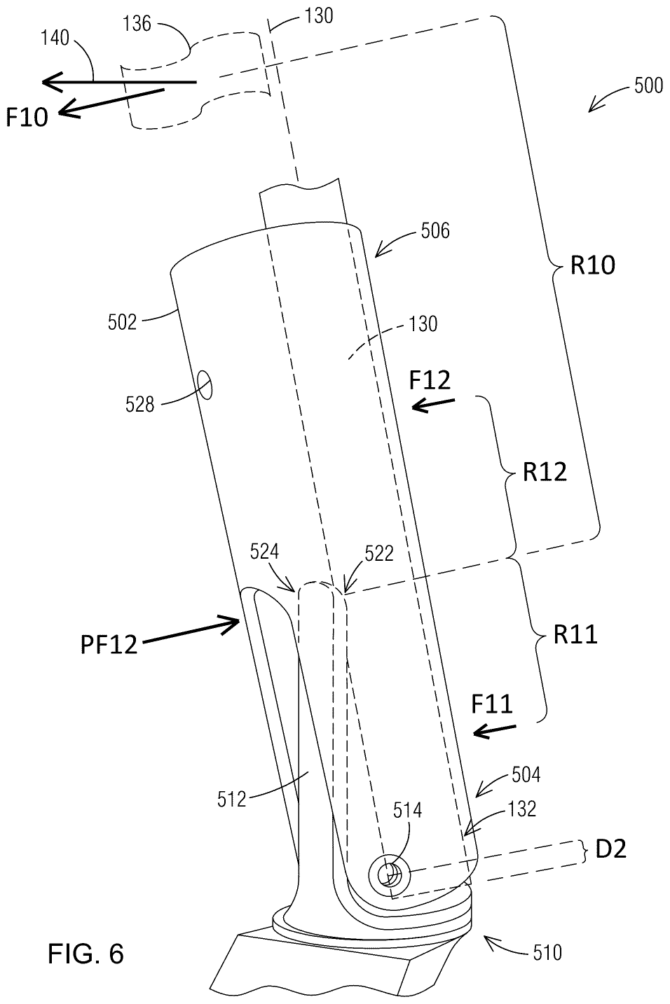

FIG. 6 shows an example configuration of the rod holder assembly 500 of FIG. 5 in the pinched configuration. In this example configuration, no set screw is used in the optional fastener openings 528. This configuration functions similar to that disclosed in FIG. 1 to FIG. 4. A difference is that the pivot joint 514 is moved closer to the first end 504 of the holder 502 and thereby closer to the base 510. This changes the magnitude of the moments generated by the flagpole 130 on the holder 502, but the operation is otherwise similar.

As FIG. 6 shows, the external force 140 (e.g., wind, manual tilting) generates a force F10 perpendicular to the flagpole 130. The force F10 tilts the flagpole 130 until the flagpole 130 contacts the contact surface 522. While tilting, the flagpole 130 simultaneously or subsequently tilts the holder 502 until reaching the pinched configuration shown. This occurs in much the same way as described regarding FIG. 1 to FIG. 4.

Force F10 at radius R10 creates a counterclockwise moment around the contact surface 522.

In this example embodiment, there are no optional interior surface grip features 126. Consequently, the flagpole 130 may be in continuous or intermittent contact with the interior surface along the entire length of the portion of the flagpole 130 in the holder 502, depending on the configuration of the interior surface. As such, the holder 502 may impart force to the flagpole 130 all along the portion of the flagpole 130 disposed within the holder 502. Continuous forces may be modeled as point forces, as is done here.

Point force F11 represents forces within imparted to the flagpole 130 by the holder 502 from the contact surface 522 downward. Point force F11 at radius R11 imparts a clockwise moment to the flagpole 130.

Point force F12 represents forces imparted to the flagpole 130 by the holder 502 from the contact surface 522 upward. Point force F12 at radius R12 imparts a counter clockwise moment to the flagpole 130. Flex of the flagpole 130 may at least partially separate the flagpole 130 from the holder 502 from the contact surface 522 upward. This would reduce or eliminate point force F12.

In the equilibrium pinched configuration shown, the clockwise moments counter all the counterclockwise moments on the flagpole 130.

The pinching force imparted on the flagpole 130 by the contact surface 522 is opposite in direction and equal in magnitude to the sum of forces F10, F11, and F12. Here again, a magnitude of the force PF12, the pinching force, will be proportional to the magnitude of the force F10. As the external force 140 and associated first force F1 increase, the force F11 and the force F12 will increase proportionally to maintain the equilibrium of the moments. Since pinching force PF12 is the sum of forces F10, F11, and F12, proportional increases to F10, F11, and F12 cause the pinching force PF12 to likewise increase proportionally.

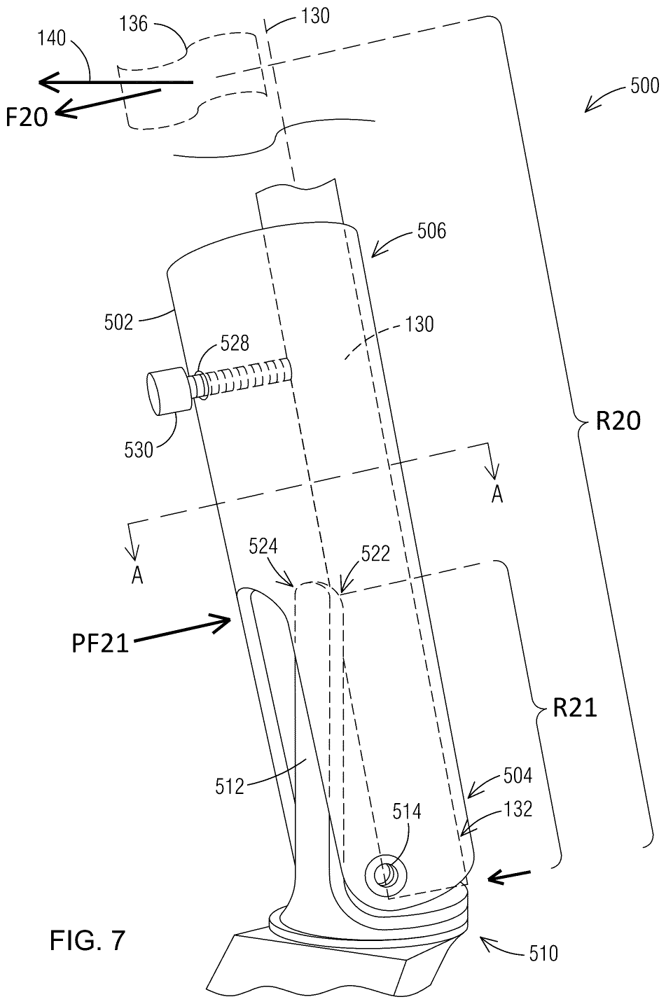

FIG. 7 shows an alternate example configuration of the rod holder assembly 500 of FIG. 5 in the pinched configuration. In this example configuration, a set screw 530 is used in the optional fastener openings 528. By tightening the flagpole 130 against the holder 502 via the set screw 530, the flagpole 130 is no longer able to move relative to the holder 502 or pivot around the contact surface 522. The flagpole 130 and the holder 502 essentially become one body that pivots about the pivot joint 514. This changes the mechanics.

The first force F20 at radius F20 from the pivot joint 514 creates a counterclockwise first moment. The pinch force PF21 at radius 21 from the pivot joint 514 creates a clockwise pinch force moment that maintains equilibrium with the counterclockwise first moment. The pinch force PF21 is proportional to the first force F20 by a ratio R20/R21.

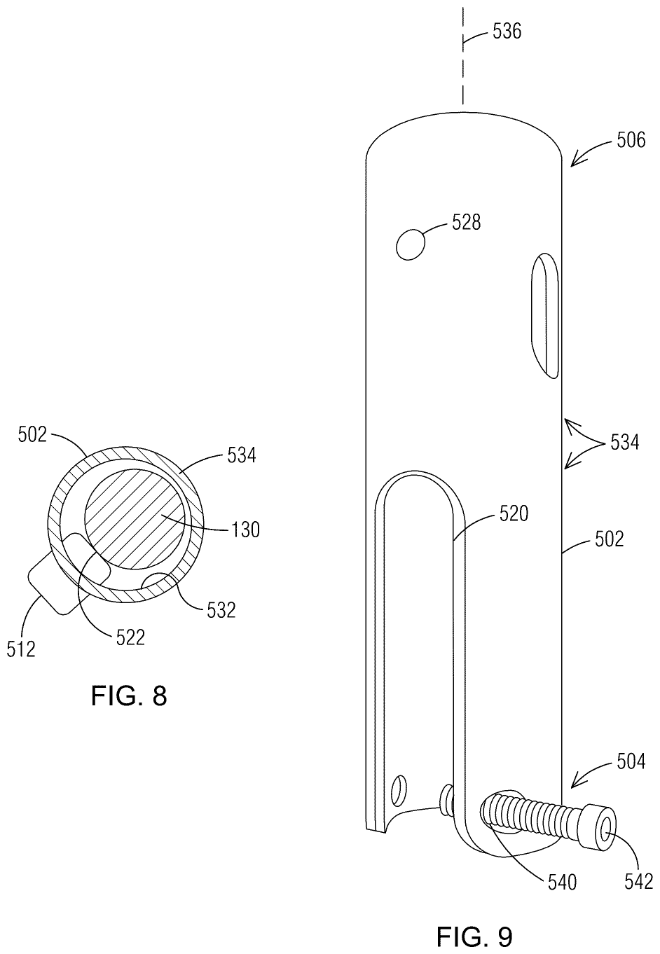

FIG. 8 shows a cross section taken along line A-A of FIG. 7. The interior surface 532 has a concave shape in this cross section. A root 534 of the concave shape is disposed opposite the contact surface 522. The root 534 extends from the first end 504 to the second end 506. In the pinched configuration shown in FIG. 8, the flagpole 130 has no option but to align with the root 534. This arrangement thereby ensures the flagpole 130 points in the desired direction by orienting the U shape and the root 534 in the desired direction. The concave shape need not be U shaped. It may have a V shape or any other shape that locks the flagpole 130 into a particular orientation.

FIG. 9 shows the holder 502 and various aspects thereof of the rod holder assembly 500 of FIG. 5, including a hole 540 that is part of the pivot joint 514. The pivot joint 541 further includes the set screw 542.

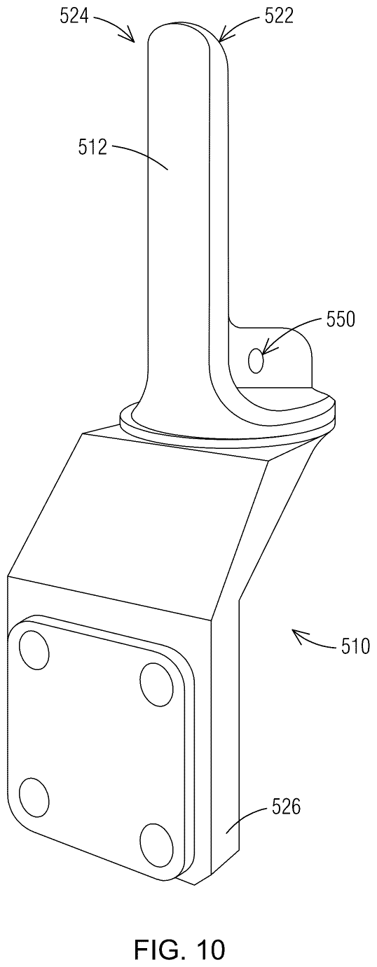

FIG. 10 shows the base 510 and various aspects thereof of the rod holder assembly 500 of FIG. 5, including a hole 550 for the set screw 542 of the pivot joint 514.

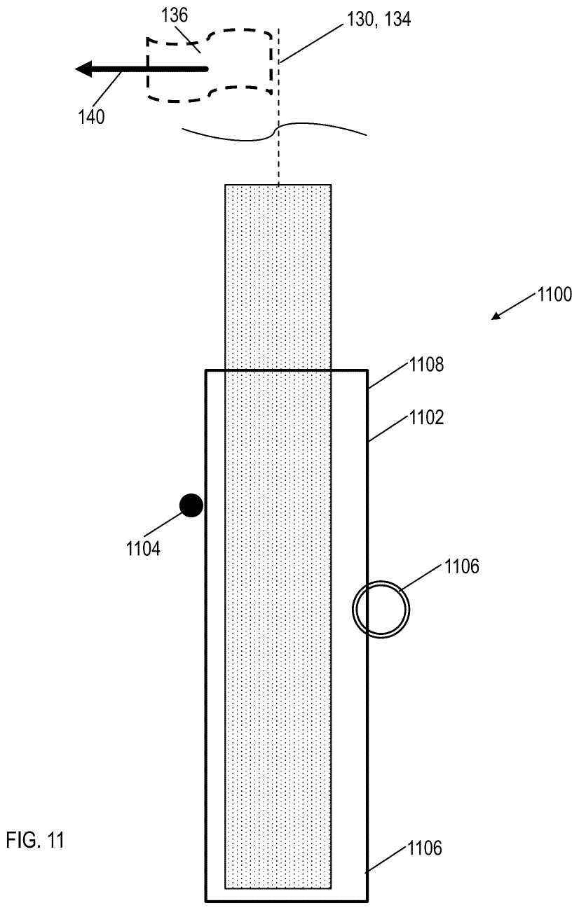

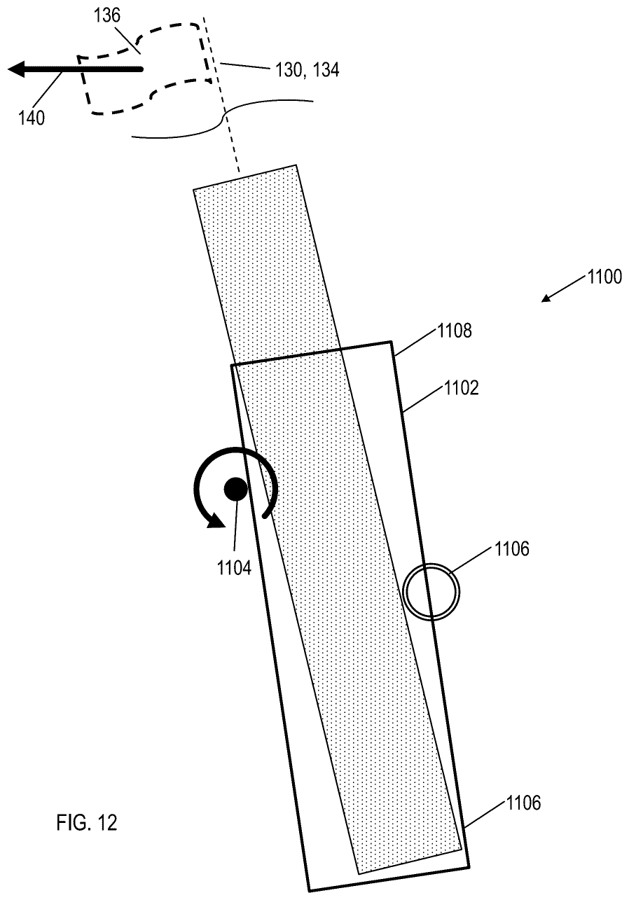

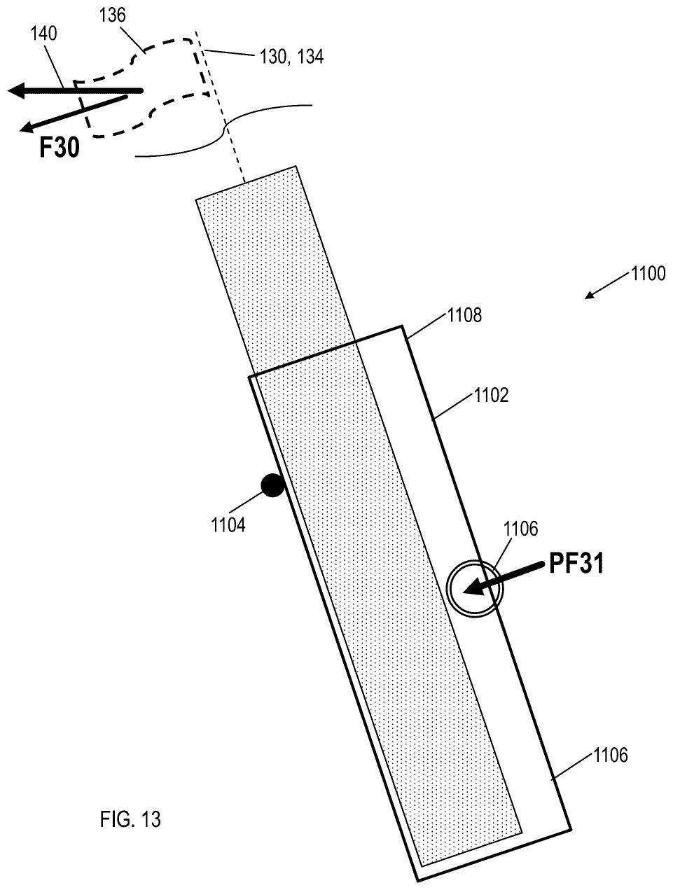

FIG. 11 to FIG. 13 are schematic representations of another alternate example embodiment of a rod holder assembly 1100 tilting from the unpinched configuration to the pinched configuration. The pivot joint 1104 and the pinching element 1106 are relocated to show another of many possible variations on the concepts presented herein. The rod holder assembly 1100 functions like that of FIG. 1 to FIG. 3 in that initially the holder 1102 rotates about the pivot joint 1104 with the flagpole 130, and the flagpole 130 then abuts the pinching element 1106 and moves the holder 1102 about the pivot joint 1104 to reach the pinched configuration. However, in this example embodiment, the flagpole pushes left on the second end 1108 of the holder 1102 to kick the first end 1110 to the right and into the pinched configuration. This can be seen between FIG. 12 and FIG. 13.

As with the other example embodiments, increasing the external force 140 proportionally increases the first force F30, which proportionally increases the pinching force PF31.

An amount of tilt can be adjusted by moving location of the pivot joint 1104 and/or the location of the pinching element 1106 as desired. For example, moving the pivot joint 1104 down and/or to the left will permit greater tilt. Moving the pivot joint 1104 up and/or to the right will permit lesser tilt.

From the foregoing it can be seen that the rod holder disclosed herein both increases the ease of use and retention efficiency and does so via a very simple and easy to use device. Consequently, the rod holder assembly represents an improvement in the art.

While various embodiments of the present invention have been shown and described herein, it will be obvious that such embodiments are provided by way of example only. Numerous variations, swapping of features among embodiments, changes, and substitutions may be made without departing from the invention herein. Accordingly, it is intended that the invention be limited only by the spirit and scope of the appended claims.

The invention claimed is:

1. An apparatus, comprising:
a holder configured to hold a rod, wherein the holder is configured to tilt about a pivot joint; and
a pinching element held in a fixed position relative to the holder and comprising a contact surface;
wherein a distance between the contact surface and an interior surface of the holder opposite the contact surface decreases as the holder tilts about the pivot joint toward a pinched configuration.

2. The apparatus of claim 1, wherein the holder comprises: a first end configured to retain the rod disposed in the holder; and a second end that is open to receive the rod, wherein the contact surface is disposed between the pivot joint and the second end.

3. The apparatus of claim 2, further comprising a base disposed at the first end of the holder to which the holder is secured via the pivot joint.

4. The apparatus of claim 3, wherein the base comprises the pinching element, and wherein the pinching element extends from the base toward the second end.

5. The apparatus of claim 4, wherein the interior surface of the holder comprises a concave shape comprising a root that is opposite the contact surface, that extends from the first end toward the second end, and which is configured to receive and orient the rod pressed therein by the contact surface.

6. The apparatus of claim 4, wherein the holder comprises a relief configured to permit the pinching element to pass into the holder as the holder tilts toward the pinched configuration.

7. The apparatus of claim 6, wherein the pinching element is configured to occupy the relief when the holder is in a fully untilted position.

8. The apparatus of claim 6, further comprising a mount configured to mount the base to an external object.

9. An apparatus, comprising:
a holder configured to receive an end of a rod therein and to tilt between an unpinched configuration when upright and a pinched configuration when tilted; and
a pinching element held fixed relative to the holder, wherein when moved toward the pinched configuration an interior surface of the holder approaches the pinching element;
wherein in the pinched configuration a contact surface of the pinching element is configured to pinch the rod between the pinching element and the interior surface.

10. The apparatus of claim 9, wherein when in the pinched configuration, the pinching element is configured to exert a pinching force that is proportional to a tilting force exerted on a distal end of the rod.

11. The apparatus of claim 9, further comprising a pivot joint configured to enable the tilting of the holder, wherein the contact surface of the pinching element is disposed between the pivot joint and an upper end of the holder.

12. The apparatus of claim 11, wherein a bottom end of the holder and the pinching element each exert a moment about the pivot joint on the rod to counter a tilting force exerted on a distal end of the rod.

13. The apparatus of claim 11, further comprising a base comprising the pinching element, wherein the base is connected to the holder via the pivot joint.

14. An apparatus, comprising:
a holder configured to hold a rod, wherein the holder is configured to tilt about a pivot joint; and
a pinching element held in a fixed position relative to the holder and configured to progressively occlude the holder as the holder tilts;
wherein when the rod is disposed in the holder and upon reaching a sufficient amount of tilt of the holder the pinching element occludes the holder enough to pinch the rod between the pinching element and the holder in a pinched configuration.

15. The apparatus of claim 14, wherein in the pinched configuration the rod is cantilevered from the holder and the pinched configuration is effective to resist an external force applied to a cantilevered end of the rod in a direction of the tilt of the rod.

16. The apparatus of claim 15, wherein in the pinched configuration a magnitude of a pinching force the pinching element exerts on the rod is proportional to a magnitude of the external force applied to the cantilevered end of the rod.

17. The apparatus of claim 15, wherein a contact point between the pinching element and the rod is disposed between the pivot joint and the cantilevered end of the rod.

18. The apparatus of claim 14, wherein the holder is configured to be tilted by the rod as the rod tilts.

19. The apparatus of claim 18, wherein upon tilting the rod an amount sufficient to cause the rod to contact the pinching element, further tilting of the rod causes the rod to tilt the holder into the pinched configuration.

20. The apparatus of claim 18, wherein in the pinched configuration an interior surface of the holder is configured to hold the rod in a select orientation.
